(19) United States
(12) Patent Application Publication
(10) Pub. No.: US 2018/0009551 A1
(43) Pub. Date: Jan. 11, 2018

(54) IMPULSE MOMENTUM PROPULSION APPARATUS AND METHOD

(71) Applicant: Mark Joseph Skowronski, Irvine, CA (US)

(72) Inventor: Mark Joseph Skowronski, Irvine, CA (US)

(21) Appl. No.: 15/620,644

(22) Filed: Jun. 12, 2017

Related U.S. Application Data
(60) Provisional application No. 62/493,554, filed on Jul. 8, 2016.

(51) Int. Cl. B64G 1/40; F03G 3/00

(52) U.S. Cl. CPC B64G 1/409; F03G 3/00

(57) ABSTRACT

An impulse momentum propulsion apparatus includes a power source and a track arranged radially relative to a vertical axis with a proximal end of the track nearest the vertical axis and a distal end of the track farthest from the vertical axis, the track powered by the power source to rotate about the vertical axis. The apparatus further includes a mass constrained to move along the track and a linear actuator that moves the mass from the distal end of the track to the proximal end of the track when the primary mass arrives at the distal end of the track due to centrifugal force acting on the mass caused by the rotation of the track. A net reaction force acting on the track over a full rotation of the track includes a non-zero propulsive force component in a propulsion direction.

### CROSS-REFERENCE TO RELATED APPLICATION(S)

This application relates to and claims the benefit of U.S. Provisional Application No. 62/493,554 filed Jul. 8, 2016 and entitled “Impulse momentum propulsion,” the entire disclosure of which is hereby wholly incorporated by reference.

### STATEMENT RE: FEDERALLY SPONSORED RESEARCH/DEVELOPMENT

Not Applicable

### BACKGROUND

### Technical Field

The present disclosure relates generally to propulsion, and more particularly, to propulsion by a propellantless drive.

### Related Art

In some settings, such as outer space, ordinary terrestrial propulsion mechanisms are impractical because there is no surface or fluid (e.g. air) to propel against. In the case of spacecraft propulsion, conventional propulsion mechanisms include, most notably, rocket engines, whose principle of operation involves the expelling of a propellant or reaction mass from the spacecraft to produce an opposite momentum of the spacecraft in the desired propulsion direction. However, propellant is irretrievable once expelled, and therefore fundamentally limited. Propellantless mechanisms are known as well, typically making use of external electromagnetic or gravitational fields to achieve propulsion. However, such mechanisms are mostly theoretical and have yet to be developed enough for widespread practical use.

### BRIEF SUMMARY

The present disclosure contemplates various apparatuses and methods for overcoming the above drawbacks accompanying the related art. One aspect of the embodiments of the invention is an impulse momentum propulsion apparatus. The apparatus includes a power source, a primary track arranged radially relative to a vertical axis with a proximal end of the primary track nearest the vertical axis and a distal end of the primary track farthest from the vertical axis, the primary track powered by the power source to rotate about the vertical axis in a first rotational direction, a primary mass constrained to move along the primary track, and a primary linear actuator that moves the primary mass from the distal end of the primary track to the proximal end of the primary track when the primary mass arrives at the distal end of the primary track due to centrifugal force acting on the primary mass caused by the rotation of the primary track. A net reaction force acting on the primary track over a full rotation of the primary track includes a non-zero propulsive force component in a propulsion direction.

Another aspect of the embodiments of the invention is a spacecraft. The spacecraft includes a hull, a power source, a primary track arranged radially relative to a vertical axis with a proximal end of the primary track nearest the vertical axis and a distal end of the primary track farthest from the vertical axis, the primary track powered by the power source to rotate about the vertical axis in a first rotational direction relative to the hull, a primary mass constrained to move along the primary track, and a primary linear actuator that moves the primary mass from the distal end of the primary track to the proximal end of the primary track when the primary mass arrives at the distal end of the primary track due to centrifugal force acting on the primary mass caused by the rotation of the primary track. A net reaction force acting on the primary track over a full rotation of the primary track includes a non-zero propulsive force component in a propulsion direction of the hull.

Another aspect of the embodiments of the invention is a method of impulse momentum propulsion. The method includes providing a track arranged radially relative to a vertical axis with a proximal end of the track nearest the vertical axis and a distal end of the track farthest from the vertical axis, providing a mass constrained to move along the track, rotating the track about the vertical axis, as the mass moves from the proximal end of the track to the distal end of the track due to centrifugal force acting on the mass caused by the rotation of the track, controlling the track and/or the mass such that the movement of the mass from the proximal end of the track to the distal end of the track occurs over the course of a predetermined portion of a rotation of the track, and moving the mass from the distal end of the track to the proximal end of the track when the mass arrives at the distal end of the track. A net reaction force acting on the track over a full rotation of the track includes a non-zero propulsive force component in a propulsion direction.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a schematic side view of an impulse momentum propulsion apparatus;

FIG. 2A illustrates a schematic top view of a primary disc of the impulse momentum propulsion apparatus, along with associated components thereof;

FIG. 2B illustrates a schematic top view of a counterbalance disc of the impulse momentum propulsion apparatus, along with associated components thereof;

FIG. 3A illustrates a schematic top view of the primary disc and the counterbalance disc of the impulse momentum propulsion apparatus in an initial position at a time t=t₀;

FIG. 3B illustrates a schematic top view of the primary disc and the counterbalance disc of the impulse momentum propulsion apparatus in a subsequent position at a time t=t₁;

FIG. 3C illustrates a schematic top view of the primary disc and the counterbalance disc of the impulse momentum propulsion apparatus in a subsequent position at a time t=t₂;

FIG. 3D illustrates a schematic top view of the primary disc and the counterbalance disc of the impulse momentum propulsion apparatus in a subsequent position at a time t=t₃;

FIG. 3E illustrates a schematic top view of the primary disc and the counterbalance disc of the impulse momentum propulsion apparatus in a subsequent position at a time t=t₄;

FIG. 3F illustrates a schematic top view of the primary disc and the counterbalance disc of the impulse momentum propulsion apparatus in a subsequent position at a time t=t₅;

FIG. 3G illustrates a schematic top view of the primary disc and the counterbalance disc of the impulse momentum propulsion apparatus in a subsequent position at a time t=t₆;

FIG. 3H illustrates a schematic top view of the primary disc and the counterbalance disc of the impulse momentum propulsion apparatus in a subsequent position at a time t=t₇;

FIG. 3I illustrates a schematic top view of the primary disc and the counterbalance disc of the impulse momentum propulsion apparatus in a subsequent position at a time t=t₈;

FIG. 4 illustrates an example control diagram of the impulse momentum propulsion apparatus; and

FIG. 5 illustrates an example operational flow in relation to the impulse momentum propulsion apparatus.

### DETAILED DESCRIPTION

The present disclosure encompasses various embodiments of apparatuses and methods for impulse momentum propulsion. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

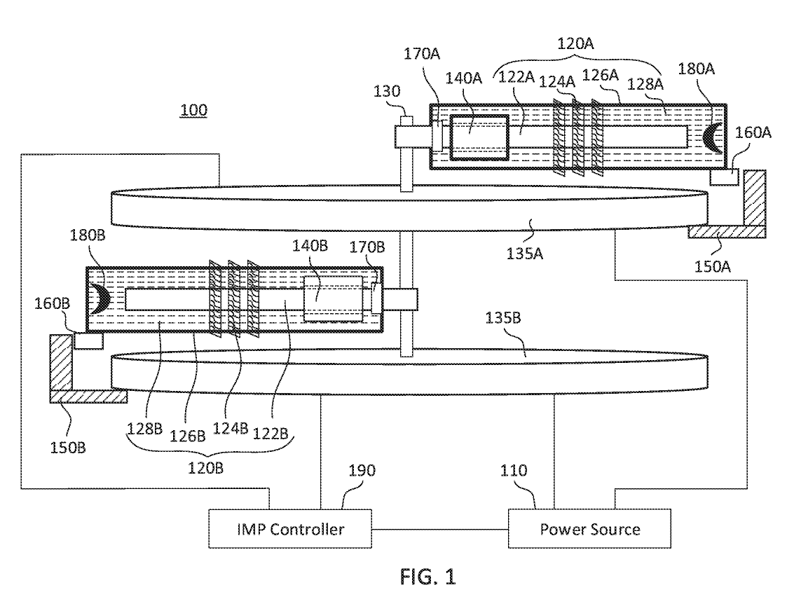

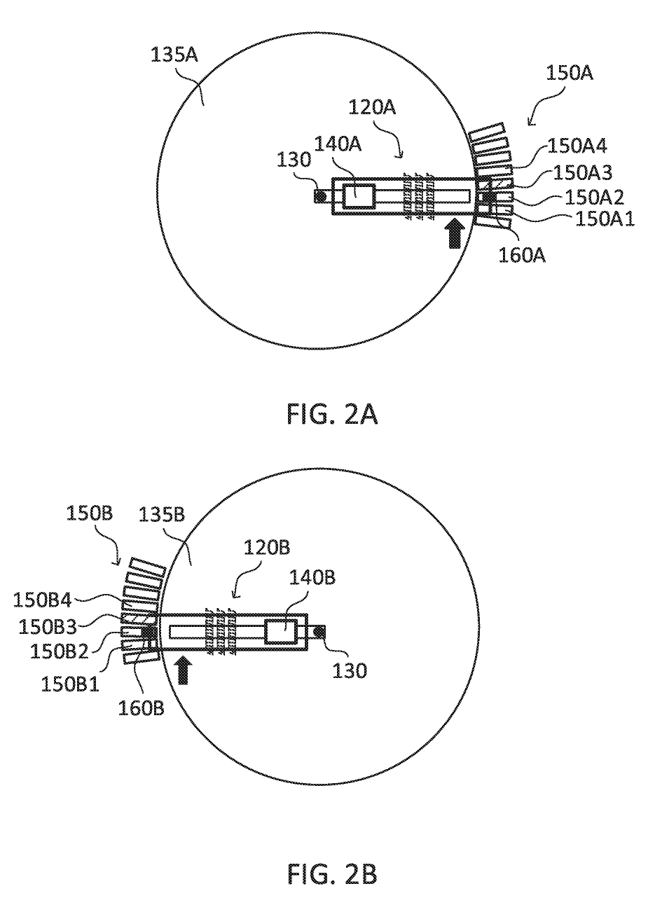

FIG. 1 illustrates a schematic side view of an impulse momentum propulsion apparatus 100. Using generated and/or recycled power, the impulse momentum propulsion apparatus 100 rotates a radially oriented track. A mass is constrained to move along the track, and a centrifugal force acting on the mass produces an equal and opposite reaction force on the track. During at least a portion of a full rotation of the track, the mass is moved radially inward, also producing an equal and opposite reaction force on the track. The mass and/or track is controlled such that the net reaction force over a full rotation of the track includes a non-zero propulsive force component in a desired propulsion direction of the impulse momentum propulsion apparatus 100. The impulse momentum propulsion apparatus 100 includes a power source 110, a primary track 120A, a vertical axis 130, a primary disc 135A, a primary mass 140A, a primary rotational actuator 150A, a primary rotational position sensor 160A, a primary linear position sensor 170A, a primary kinetic energy return 180A, and an impulse momentum propulsion (IMP) controller 190. The impulse momentum propulsion apparatus 100 further includes a counterbalance track 120B, a counterbalance disc 135B, a counterbalance mass 140B, a counterbalance rotational actuator 150B, a counterbalance rotational position sensor 160B, a counterbalance linear position sensor 170B, and a counterbalance kinetic energy return 180B. FIGS. 2A and 2B respectively illustrate schematic top views of the primary disc 135A and the counterbalance disc 135B, along with associated components thereof.

The power source 110 provides power to various components of the impulse momentum propulsion apparatus 100. For ease of illustration, the connections of the power source 110 to the impulse momentum propulsion apparatus 100 are shown schematically to include a connection to the IMP controller 190 as well as to the primary disc 135A and the counterbalance disc 135B. As will become apparent from the description below concerning the various components receiving power from the power source 110, the connection to the discs 135A, 135B is only a symbolic representation and power may connect to various components of the impulse momentum propulsion apparatus 100 directly or by wiring via an intermediate component such as the discs 135A, 135B. The power source 100 may supply electrical power to the components of the impulse momentum propulsion apparatus 100 and may include, for example, a photovoltaic, Rankine cycle-based, thermionic, nuclear, or any other known power generation system or a combination thereof.

The primary track 120A is arranged radially relative to the vertical axis 130 with a proximal end of the primary track 120A nearest the vertical axis 130 and a distal end of the primary track 120A farthest from the vertical axis 130. The primary track 120A is powered by the power source 110 to rotate about the vertical axis 130 in a first rotational direction, e.g. counterclockwise as shown by the arrow in FIG. 2A. The counterbalance track 120B is similarly arranged radially relative to the vertical axis 130 with a proximal end of the counterbalance track 120B nearest the vertical axis 130 and a distal end of the counterbalance track 120B farthest from the vertical axis 130. The counterbalance track 120B is powered by the power source 110 to rotate about the vertical axis 130 in a second rotational direction opposite the first rotational direction, e.g. clockwise as shown by the arrow in FIG. 2B. As shown in FIG. 1, the rotation of the primary track 120A and the rotation of the counterbalance track 120B are in parallel planes orthogonal to the vertical axis 130.

The primary track 120A may be fixed to the primary disc 135A with the primary disc 135A rotating about the vertical axis 130 together with the primary track 120A. For example, the primary track 120A may be formed integrally with the primary disc 135A. Alternatively, the primary disc 135A may remain stationary relative to the rotation of the primary track 120A and serve as a reference for rotational position or velocity measurements. Similarly, the counterbalance track 120B may be fixed to the counterbalance disc 135B with the counterbalance disc 135B rotating about the vertical axis 130 together with the counterbalance track 120B. For example, the counterbalance track 120B may be formed integrally with the counterbalance disc 135B. Alternatively, the counterbalance disc 135B may remain stationary relative to the rotation of the counterbalance track 120B and serve as a reference for rotational position or velocity measurements.

Depending on the particular embodiment, the axis 130 and the primary and counterbalance discs 135A, 135B may or may not define the positions of actual physical components. For example, if the primary and counterbalance tracks 120A, 120B rotate about a physical rod positioned at the axis 130 (e.g. the rod may be threaded through holes in the tracks 120A, 120B or otherwise connected by a rotational coupling), then the discs 135A, 135B may be only conceptual traces or projections of the rotation of the tracks 120A, 120B and need not be physical components. On the other hand, if the tracks 120A, 120B are formed integrally with the discs 135A, 135B and rotate by virtue of the rotation of the discs 135A, 135B, then there may be no need for a rod or other physical component positioned at the axis 130.

The primary mass 140A is constrained to move along the primary track 120A. Similarly, the counterbalance mass 140B is constrained to move along the counterbalance track 120B. For example, the tracks 120A, 120B may include rods having circular or non-circular profile such as guide cylinders 122A, 122B, and each of the masses 140A, 140B may have a correspondingly shaped borehole threaded by the guide cylinders 122A, 122B and allow for a sliding motion of the masses 140A, 140B on the guide cylinders 122A, 122B. If rollers are provided on the guide cylinders 122A, 122B or masses 140A, 140B, or if the masses 140A, 140B are rounded (e.g. donut-shaped), a rolling motion rather than a sliding motion may be achieved. Alternatively, the tracks 120A, 120B may include cylindrical or semi-cylindrical boreholes or grooves, e.g. in the discs 135A, 135B, or may be hollowed-out cylinders, and the masses 140A, 140B may move along the tracks 120A, 120B either by sliding, by rolling using rollers (on the masses 140A, 140B or tracks 120A, 120B), or by rolling of the masses 140A, 140B themselves. For example, the masses 140A, 140B may be ball-shaped and may roll along the tracks 120A, 120B. In each of these examples, the masses 140A, 140B are constrained to move along the tracks 120A, 120B in the sense that they cannot depart laterally from the tracks 120A, 120B. The masses 140A, 140B may further be constrained such that they cannot fall off the ends of the tracks 120A, 120B by any suitable design (e.g. stopper, end plug, wall, etc.)

In the example shown in FIG. 1, the tracks 120A, 120B include guide cylinders 122A, 122B as described above and further include, respectively, a primary linear actuator 124A and a counterbalance linear actuator 124B, which may be powered by the power source 110. As described in more detail below, the primary linear actuator 124A moves the primary mass 140A from the distal end of the primary track 120A to the proximal end of the primary track 120A when the primary mass 140A arrives at the distal end of the primary track 120A due to centrifugal force acting on the primary mass 140A caused by the rotation of the primary track 120A. Similarly, the counterbalance linear actuator 124B moves the counterbalance mass 140B from the distal end of the counterbalance track 120B to the proximal end of the counterbalance track 120B when the counterbalance mass 140B arrives at the distal end of the counterbalance track 120B due to centrifugal force acting on the counterbalance mass 140B caused by the rotation of the counterbalance track 120B. The primary linear actuator 124A and the counterbalance linear actuator 124B may function by any known mechanism to move the primary mass 140A and the counterbalance mass 140B, including linear motors, pistons for pushing the masses 140A, 140B, pulleys for pulling the masses 140A, 140B, mechanical actuation by rods and gears, magnetic actuation by means of solenoids, etc. In the example shown in FIG. 1, the primary linear actuator 124A includes a control solenoid that the primary mass 140A moves through as it moves along the primary track 120A, and the primary linear actuator 124A moves the primary mass 140A by applying an electric current to the control solenoid to produce a magnetic force. Similarly, the counterbalance linear actuator 124B includes a control solenoid that the counterbalance mass 140B moves through as it moves along the counterbalance track 120B, and the counterbalance linear actuator 124B moves the counterbalance mass 140B by applying an electric current to the control solenoid to produce a magnetic force. To this end, the masses 140A, 140B may be made of or include a magnetic material.

The control solenoids of the tracks 120A, 120B may further be used to control the movement of the masses 140A, 140B, irrespective of whether the control solenoids are utilized by the linear actuators 124A, 124B (e.g. even if the linear actuators 124A, 124B use other mechanisms to move the masses 140A, 140B). For example, the control solenoids may be used to slow the masses 140A, 140B as described in more detail below. Alternatively, or additionally, the primary track 120A may further include a chamber 126A filled with a viscous fluid 128A (e.g. liquid or gas) that the primary mass 140A traverses as it moves along the primary track 120A. Similarly, the counterbalance track 120B may further include a chamber 126B filled with a viscous fluid 128B that the counterbalance mass 140B traverses as it moves along the primary track 120B. Like the control solenoids, the viscous fluid 128A, 128B may be used to slow the masses 140A, 140B as described below. The amount of friction may be controlled by controlling the temperature of the viscous fluid 128A, 128B. To this end, any known temperature control mechanism may be employed. For example, the temperature of the viscous fluid 128A, 128B may be controlled for an optimum viscosity that allows the masses 140A, 140B to move with maximum velocity while still producing an equal and opposite reaction force. Controlling the velocity of the masses 140A, 140B in this way may further help prevent the apparatus 100 from becoming damaged due to excessive acceleration and resulting impact between components of the apparatus 100.

The rotational actuators 150A, 150B may be powered by the power source 110 to rotate the tracks 120A, 120B, respectively, and may control the speeds of rotation thereof. The rotational actuators 150A, 150B may function by any known mechanism to move the tracks 120A, 120B, including, for example, magnetic actuation by means of electromagnetic guide coils or a motor with appropriate gearing. In the example shown in FIGS. 1, 2A, and 2B, the rotational actuators 150A, 150B include electromagnetic guide coils that may be selectively energized to increase or decrease the rotational speed of the tracks 120A, 120B. For ease of illustration, the electromagnetic guide coils of the rotational actuators 150A, 150B have been drawn at only a portion of the full range of rotation of the tracks 120A, 120B. However, the electromagnetic guide coils of the rotational actuators 150A, 150B may extend or be distributed throughout the full range of rotation of the tracks 120A, 120B. FIGS. 2A and 2B shows an example of electromagnetic guide coils including additional detail of coils 150A1, 150A2, 150A3, and 150A4 and coils 150B1, 150B2, 150B3, and 150B4. Coils 150A1, 150A2, 150A3, 150A4, etc. may be sequentially energized and de-energized such that the coil just ahead the track 120A (e.g. coil 150A3) creates an electromagnetic field to move the track 120A. Similarly, coils 150B1, 150B2, 150B3, 150B4, etc. may be sequentially energized and de-energized such that the coil just ahead of the track 120B (e.g. coil 150B3) creates an electromagnetic field to move the track 120B.

The rotational position sensor 160A is arranged to detect a rotational position of the primary track 120A relative to the vertical axis 130. Similarly, the rotational position sensor 160B is arranged to detect a rotational position of the counterbalance track 120B relative to the vertical axis 130. In the example shown in FIGS. 1, 2A, and 2B, the rotational position sensors 160A, 160B are represented by rectangular projections on the distal end of each track 120A, 120B for simplicity. However, each of the rotational position sensors 160A, 160B may include complimentary components disposed on and off the rotating track 120A, 120B. The rotational position sensors 160A, 160B may sense rotational position by any known mechanism, including Hall effect, optical sensing, potentiometer, encoder, etc.

The linear position sensor 170A is arranged to detect a linear position of the primary mass 140A relative to the primary track 120A. Similarly, the linear position sensor 170B is arranged to detect a linear position of the counterbalance mass 140B relative to the counterbalance track 120B. In the example shown in FIG. 1, the linear position sensors 170A, 170B are represented by cylindrical pieces on the proximal end of each track 120A, 120B surrounding the guide cylinders 120A, 120B for simplicity. However, each of the linear position sensors 170A, 170B may include complimentary components disposed on and off the moving mass 140A, 140B. The rotational position sensors 170A, 170B may sense linear position by any known mechanism, including, optical sensing, potentiometer, encoder, etc.

The kinetic energy return 180A captures kinetic energy of the primary mass 140A when the primary mass 140A arrives at the distal end of the primary track 120A due to centrifugal force acting on the primary mass 140A caused by the rotation of the primary track 120A. Similarly, the kinetic energy return 180B captures kinetic energy of the counterbalance mass 140B when the counterbalance mass 140B arrives at the distal end of the counterbalance track 120B due to centrifugal force acting on the counterbalance mass 140B caused by the rotation of the counterbalance track 120B. At the moment the mass 140A (or 140B) reaches the distal end of the track 120A (or 120B), it has kinetic energy due to its motion. The kinetic energy return 180A (or 180B) captures this kinetic energy or a portion thereof for re-use by the impulse momentum propulsion apparatus 100. In the simplest case, the kinetic energy return 180A (or 180B) may include a spring biased in a direction opposing the motion of the mass 140A (or 140B) as the mass approaches the distal end of the track 120A (or 120B). Upon arriving at the distal end of the track 120A (or 120B), the mass 140A (or 140B) compresses the spring, which decelerates the mass and converts the kinetic energy of the mass into potential energy stored in the spring. The stored kinetic energy may then be re-used as the spring extends, either immediately thereafter or at a later time if the spring is held in the compressed position. As the spring extends, the stored potential energy is converted back to kinetic energy of the mass 140A (or 140B), accelerating the mass 140A (or 140B) from the distal end toward the proximal end of the track 120A (or 120B). In this case, the primary linear actuator 124A and the counterbalance linear actuator 124B may be regarded as including the springs.

Other non-spring mechanisms are envisioned as well, including linear generators or compressed gases that decelerate the masses 140A, 140B and capture and re-use the kinetic energy, either by direct mechanical re-use (e.g. expansion of a compressed and heated gas) or by converting the mechanical energy to electrical energy to be used anywhere in the impulse momentum propulsion apparatus 100 or larger system (e.g. spacecraft). Alternatively, the kinetic energy returns 180A, 180B may be omitted and control solenoids (e.g. the control solenoids of the linear actuators 124A, 124B) or simple friction brake mechanisms may be used to decelerate the masses 140A, 140B without re-using kinetic energy.

The IMP controller 190 may be powered by the power source 110 (and/or recycled energy captured by the kinetic energy returns 180A, 180B) to control the entire system of the impulse momentum propulsion apparatus 100. As described in more detail below, the IMP controller 190 may, for example, send control signals to and receive feedback signals from the various components of the momentum propulsion apparatus 100 in order to produce a desired propulsion speed and direction of the impulse momentum propulsion apparatus 100 or larger system (e.g. spacecraft). As in the case of the power source 110, the connections of the IMP controller 190 to the impulse momentum propulsion apparatus 100 are shown schematically to include, in addition to a connection to the power source 110, connections to the primary disc 135A and the counterbalance disc 135B. The connection to the discs 135A, 135B is only a symbolic representation, and signals may be provided to and received from various components of the impulse momentum propulsion apparatus 100 directly or by wiring via an intermediate component such as the discs 135A, 135B.

The IMP controller 190 may include, for example, a computer system having a processor such as a CPU or programmable circuitry such as a field-programmable gate array (FPGA) or programmable logic array (PLA), a system memory such as RAM for temporarily storing results of the data processing operations performed by the processor or programmable circuitry, permanent storage devices such as a hard drive for storing program instructions or state information, and other known computing components. The computer system may execute computer instructions using the processor or programmable circuitry to perform or execute the operations of various control schemes as set forth or generally contemplated by the present disclosure.

The impulse momentum propulsion apparatus 100 shown in FIGS. 1, 2A, and 2B may, for example, be a spacecraft or a part thereof, in which case the vertical axis 130 may be an axis of a hull of the spacecraft. Thus, for example, the primary track 120A (and likewise the counterbalance track 120B) may be powered by the power source 110 to rotate about the vertical axis 130 in a first (second) rotational direction relative to the hull. In this case, the propulsion direction may be defined relative to the hull as well.

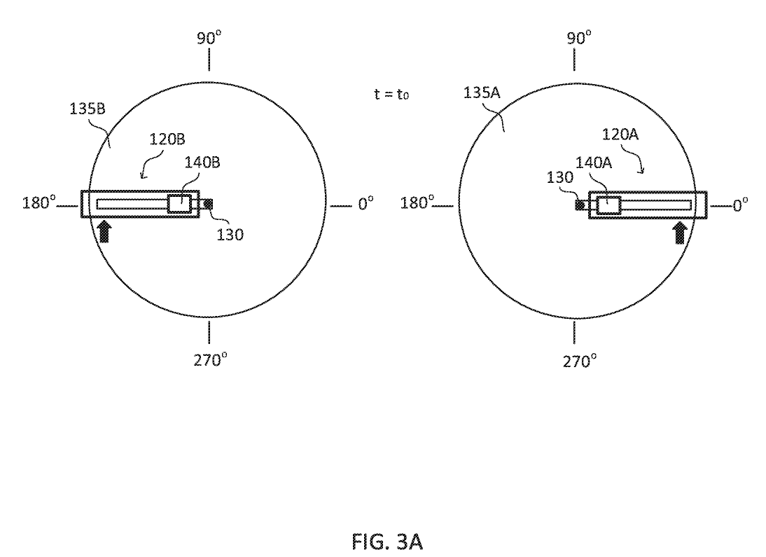

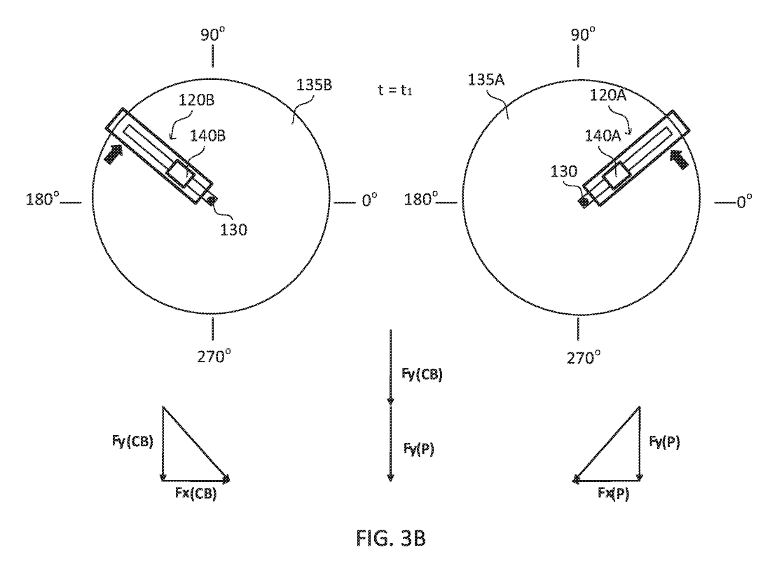

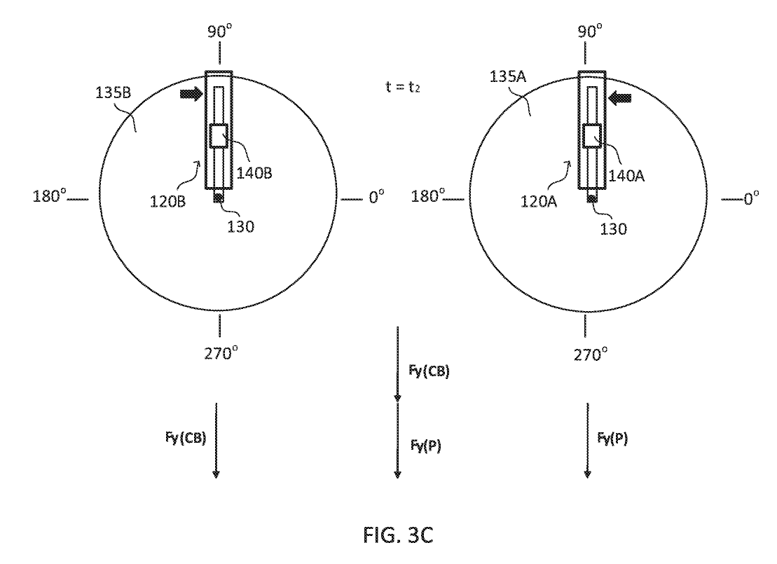

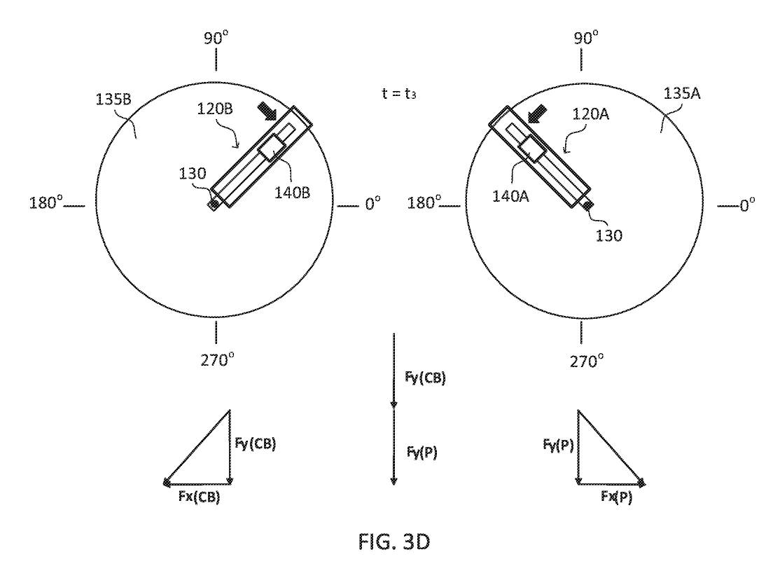

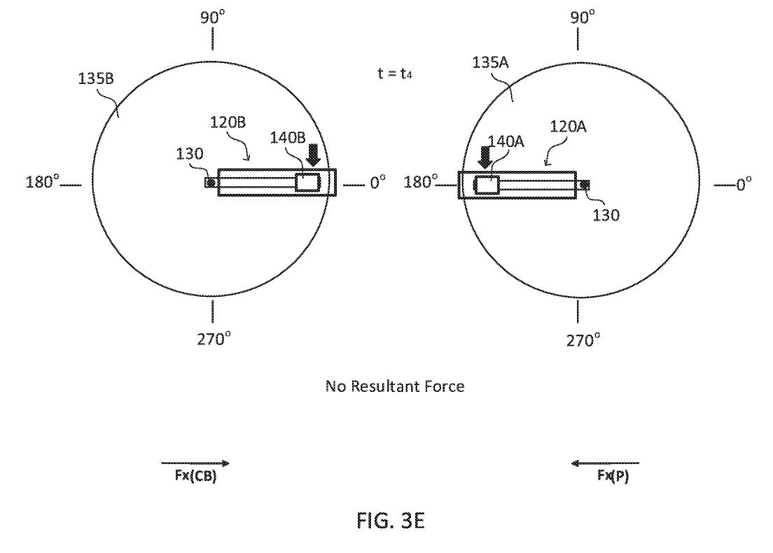

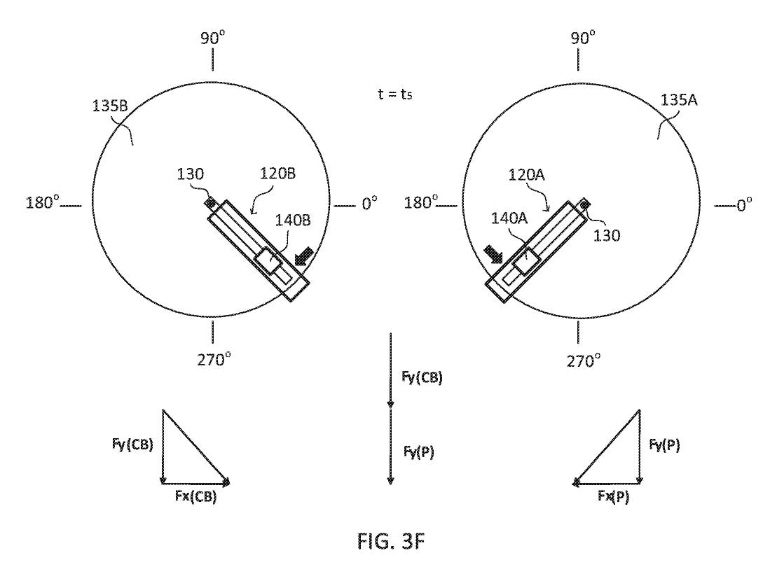

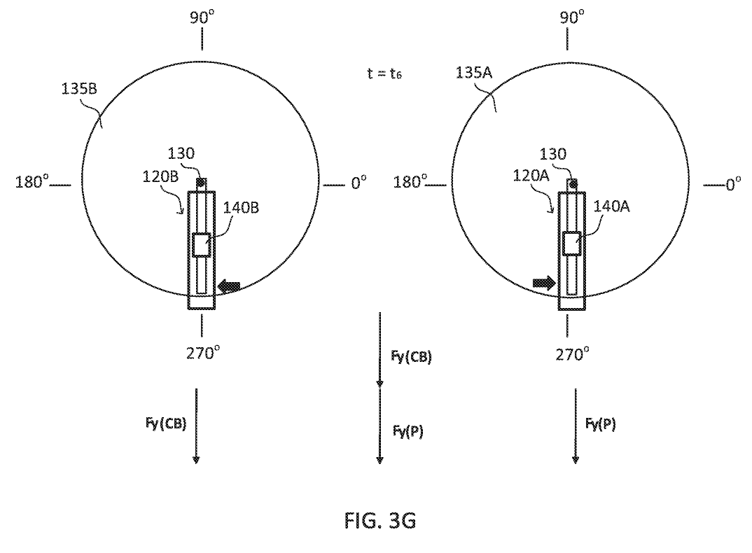

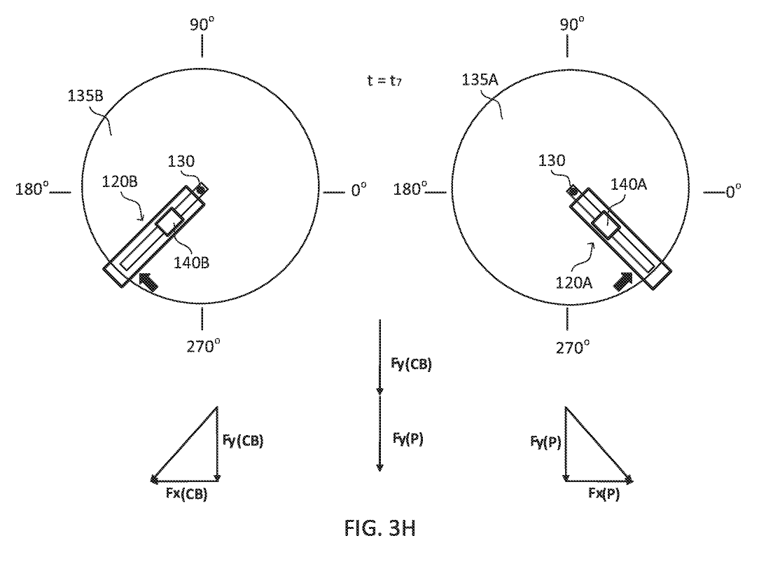

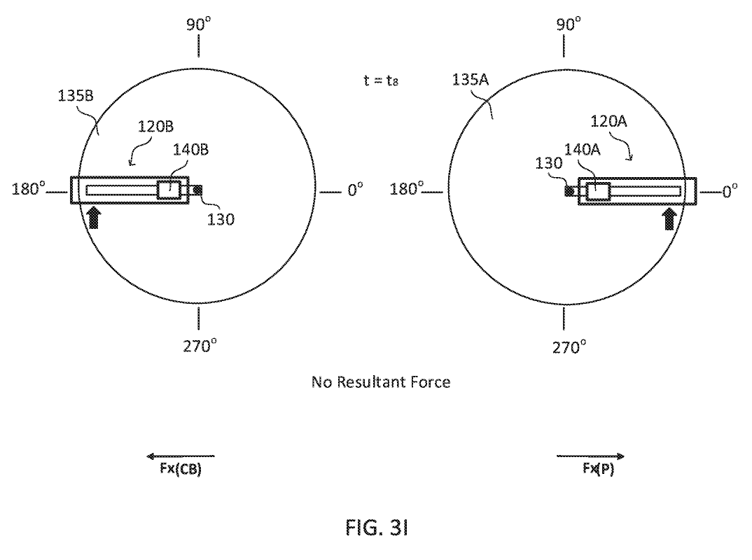

FIGS. 3A-3I illustrate schematic top views of the primary disc 135A and the counterbalance disc 135B and associated components over the course of nine snapshots in time. In each of FIGS. 3A-3I, the discs 135A, 135B are labeled at 0°, 90°, 180°, and 270° relative to an origin at the position of the vertical axis 130. FIG. 3A shows an initial position at a time t=t₀ just before the impulse momentum propulsion apparatus 100 begins to rotate the tracks 120A, 120B in the directions indicated by the arrows. The primary track 120A is at 0° and the counterbalance track is at 180°. The masses 140A, 140B are at the proximal positions of the respective tracks 120A, 120B. At this time, since there is no rotational motion of the tracks 120A, 120B, there is no centrifugal force acting on the masses 140A, 140B and no reaction force acting on the tracks 120A, 120B.

FIG. 3B shows a subsequent position at a time t=t₁ after the impulse momentum propulsion apparatus 100 has begun to rotate the tracks 120A, 120B in the directions indicated by the arrows. For example, the rotational actuators 150A, 150B may be powered by the power source 110 to rotate the tracks 120A, 120B (e.g. using electromagnetic guide coils). At time t=t₁, the primary track 120A has rotated counterclockwise to a position between 0° and 90° and the counterbalance track 120B has rotated clockwise to a position between 180° and 90°. Centrifugal forces acting on the masses 140A, 140B due to the rotation of the tracks 120A, 120B has caused the masses 140A, 140B to move about a quarter of the way from the proximal end to the distal end of their respective tracks 120A, 120B. Meanwhile, equal and opposite reaction forces of the masses 140A, 140B act on the tracks 120A, 120B in the opposite direction. As shown below the primary disc 135A, a y-component Fy(P) of the reaction force acting on the primary track 120A points in the 270° direction while an x-component Fx(P) of the reaction force acting on the primary track 120A points in the 180° direction. As shown below the counterbalance disc 135B, a y-component Fy(CB) of the reaction force acting on the counterbalance track 120B points in the 270° direction while an x-component Fx(CB) of the reaction force acting on the counterbalance track 120B points in the 0° direction. As shown between these two force diagrams, by vector addition, the x-components Fx(P) and Fx(CB) completely cancel while the y-components Fy(P) and Fy(CB) are additive, resulting in a combined force in the 270° direction. As a result, the entire momentum impulse propulsion apparatus 100 moves in the propulsion direction, in this case the 270° direction.

FIG. 3C shows a subsequent position at a time t=t₂, where the primary track 120A has rotated counterclockwise to 90° and the counterbalance track 120B has rotated clockwise to 90° . The centrifugal forces acting on the masses 140A, 140B due to the rotation of the tracks 120A, 120B has caused the masses 140A, 140B to move about halfway from the proximal end to the distal end of their respective tracks 120A, 120B. As shown below the primary disc 135A, the y-component Fy(P) of the reaction force acting on the primary track 120A points in the 270° direction while the x-component Fx(P) is zero. As shown below the counterbalance disc 135B, the y-component Fy(CB) of the reaction force acting on the counterbalance track 120B points in the 270° direction while the x-component Fx(CB) is zero. As shown between these two force diagrams, the x-components Fx(P) and Fx(CB) are non-existent and the y-components Fy(P) and Fy(CB) are again additive, resulting in a combined force in the 270° direction. The entire momentum impulse propulsion apparatus 100 thus continues to move in the propulsion direction, in this case the 270° direction.

FIG. 3D shows a subsequent position at a time t=t₃, where the primary track 120A has rotated counterclockwise to a position between 90° and 180° and the counterbalance track 120B has rotated clockwise to a position between 90° and 0°. The centrifugal forces acting on the masses 140A, 140B due to the rotation of the tracks 120A, 120B has caused the masses 140A, 140B to move about three quarters of the way from the proximal end to the distal end of their respective tracks 120A, 120B. As shown below the primary disc 135A, the y-component Fy(P) of the reaction force acting on the primary track 120A points in the 270° direction while the x-component Fx(P) of the reaction force acting on the primary track 120A points in the 0° direction. As shown below the counterbalance disc 135B, the y-component Fy(CB) of the reaction force acting on the counterbalance track 120B points in the 270° direction while the x-component Fx(CB) of the reaction force acting on the counterbalance track 120B points in the 180° direction. As shown between these two force diagrams, the x-components Fx(P) and Fx(CB) cancel while the y-components Fy(P) and Fy(CB) are again additive, resulting in a combined force in the 270° direction. The entire momentum impulse propulsion apparatus 100 thus continues to move in the propulsion direction, in this case the 270° direction.

FIG. 3E shows a subsequent position at a time t=t₄, where the primary track 120A has rotated counterclockwise to 180° and the counterbalance track 120B has rotated clockwise to 0°, each thus completing a half rotation. The centrifugal force acting on the masses 140A, 140B due to the rotation of the tracks 120A, 120B has caused the masses 140A, 140B to arrive at the distal end of their respective tracks 120A, 120B. As shown below the primary disc 135A, the y-component Fy(P) of the reaction force acting on the primary track 120A is zero and the x-component Fx(P) of the reaction force acting on the primary track 120A points in the 180° direction. As shown below the counterbalance disc 135B, the y-component Fy(CB) of the reaction force acting on the counterbalance track 120B is zero and the x-component Fx(CB) of the reaction force acting on the counterbalance track 120B points in the 0° direction. In this case, the x-components Fx(P) and Fx(CB) cancel and the y-components Fy(P) and Fy(CB) are non-existent, resulting in no combined force.

FIG. 3F shows a subsequent position at a time t=t₅, where the primary track 120A has rotated counterclockwise to a position between 180° and 270° and the counterbalance track 120B has rotated clockwise to a position between 0° and 270°. The primary linear actuator 124A has begun to actively move the primary mass 140A back from the distal end to the proximal end of the primary track 120A, and the counterbalance linear actuator 124B has begun to actively move the counterbalance mass 140B back from the distal end to the proximal end of the counterbalance track 120B. Thus, at time t=t₅, the masses 140A, 140B have moved about a quarter of the way back from the distal end to the proximal end of their respective tracks 120A, 120B.

The movement of the masses 140A, 140B by the linear actuators 124A, 124B, which is against the centrifugal forces acting on the masses 140A, 140B due to the rotation of the tracks 120A, 120B, may be via one or more of various mechanisms as discussed above, including a control solenoid as well as a spring of the kinetic energy returns 180A, 180B. For example, at time t=t₄ (referring back to FIG. 3E), when the masses 140A, 140B arrived at the distal end of their respective tracks 120A, 120B, the kinetic energy returns 180A, 180B (see FIG. 1) may have captured the kinetic energy of the masses 140A, 140B as described above. For example, as mentioned above, the kinetic energy return 180A may include a spring arranged to decelerate the primary mass 140A when it arrives at the distal end of the primary track 120A and accelerate the primary mass 140A toward the proximal end of the primary track 120A. Similarly, the kinetic energy return 180B may include a spring arranged to decelerate the counterbalance mass 140B when it arrives at the distal end of the counterbalance track 120B and accelerate the counterbalance mass 140B toward the proximal end of the counterbalance track 120B. In this way, the primary linear actuator 124A may use the captured kinetic energy to move the primary mass 140A from the distal end of the primary track 120A to the proximal end of the primary track 120A, and the counterbalance linear actuator 124B may thus use the captured kinetic energy to move the counterbalance mass 140B from the distal end of the counterbalance track 120B to the proximal end of the counterbalance track 120B. The primary linear actuator 124A and the counterbalance linear actuator 124B may be further powered by the power source 110. If the impulse momentum propulsion apparatus 100 does not include the kinetic energy returns 180A, 180B, the primary linear actuator 124A and the counterbalance linear actuator 124B may move the masses 140A, 140B from the distal end to the proximal end and may be entirely powered by the power source 110.

In FIG. 3F, as shown below the primary disc 135A, the y-component Fy(P) of the reaction force acting on the primary track 120A points in the 270° direction while the x-component Fx(P) of the reaction force acting on the primary track 120A points in the 180° direction. As shown below the counterbalance disc 135B, the y-component Fy(CB) of the reaction force acting on the counterbalance track 120B points in the 270° direction while the x-component Fx(CB) of the reaction force acting on the counterbalance track 120B points in the 0° direction. As shown between these two force diagrams, the x-components Fx(P) and Fx(CB) cancel while the y-components Fy(P) and Fy(CB) are again additive, resulting in a combined force in the 270° direction. The entire momentum impulse propulsion apparatus 100 thus continues to move in the propulsion direction, in this case the 270° direction.

FIG. 3G shows a subsequent position at a time t=t₆, where the primary track 120A has rotated counterclockwise to 270° and the counterbalance track 120B has rotated clockwise to 270°. The linear actuators 124A, 124B, against the centrifugal forces acting on the masses 140A, 140B due to the rotation of the tracks 120A, 120B, have moved the masses 140A, 140B to about halfway back from the distal end to the proximal end of their respective tracks 120A, 120B. As shown below the primary disc 135A, the y-component Fy(P) of the reaction force acting on the primary track 120A points in the 270° direction while the x-component Fx(P) is zero. As shown below the counterbalance disc 135B, the y-component Fy(CB) of the reaction force acting on the counterbalance track 120B points in the 270° direction while the x-component Fx(CB) is zero. As shown between these two force diagrams, the x-components Fx(P) and Fx(CB) are non-existent and the y-components Fy(P) and Fy(CB) are again additive, resulting in a combined force in the 270° direction. The entire momentum impulse propulsion apparatus 100 thus continues to move in the propulsion direction, in this case the 270° direction.

FIG. 3H shows a subsequent position at a time t=t₇, where the primary track 120A has rotated counterclockwise to a position between 270° and 0° and the counterbalance track 120B has rotated clockwise to a position between 270° and 180°. The linear actuators 124A, 124B, against the centrifugal forces acting on the masses 140A, 140B due to the rotation of the tracks 120A, 120B, have moved the masses 140A, 140B to about three quarters of the way back from the distal end to the proximal end of their respective tracks 120A, 120B. As shown below the primary disc 135A, the y-component Fy(P) of the reaction force acting on the primary track 120A points in the 270° direction while the x-component Fx(P) of the reaction force acting on the primary track 120A points in the 0° direction. As shown below the counterbalance disc 135B, the y-component Fy(CB) of the reaction force acting on the counterbalance track 120B points in the 270° direction while the x-component Fx(CB) of the reaction force acting on the counterbalance track 120B points in the 180° direction. As shown between these two force diagrams, the x-components Fx(P) and Fx(CB) cancel while the y-components Fy(P) and Fy(CB) are again additive, resulting in a combined force in the 270° direction. The entire momentum impulse propulsion apparatus 100 thus continues to move in the propulsion direction, in this case the 270° direction.

FIG. 3I shows a subsequent position at a time t=t₈, where the primary track 120A has rotated counterclockwise to 0° and the counterbalance track 120B has rotated clockwise to 180°, each thus completing a full rotation and arriving at the same positions as the initial positions of FIG. 3A. The linear actuators 124A, 124B, against the centrifugal forces acting on the masses 140A, 140B due to the rotation of the tracks 120A, 120B, have moved the masses 140A, 140B all the way back to the proximal end of their respective tracks 120A, 120B. As shown below the primary disc 135A, the y-component Fy(P) of the reaction force acting on the primary track 120A is zero and the x-component Fx(P) of the reaction force acting on the primary track 120A points in the 0° direction. As shown below the counterbalance disc 135B, the y-component Fy(CB) of the reaction force acting on the counterbalance track 120B is zero and the x-component Fx(CB) of the reaction force acting on the counterbalance track 120B points in the 180° direction. In this case, the x-components Fx(P) and Fx(CB) cancel and the y-components Fy(P) and Fy(CB) are non-existent, resulting in no combined force. The rotations of the tracks 120A, 120B may thereafter continue with the positions shown in FIGS. 3B, 3C, etc.

In the example shown in FIGS. 3A-3I, a combined reaction force on the primary and counterbalance tracks 120A, 120B is consistently in the 270° direction except when it is absent at the two extremes of FIGS. 3E and 3I (or A). Thus, a net reaction force acting on the primary track 120A over a full rotation of the primary track 120A includes a non-zero propulsive force component in a propulsion direction, in this example the 270° direction. In the case where the impulse momentum propulsion apparatus 100 is a spacecraft or a part thereof and the vertical axis 130 is an axis of a hull of the spacecraft, it can be said that a net reaction force acting on the primary track 120A over a full rotation of the primary track 120A includes a non-zero propulsive force component in a propulsion direction of the hull of the spacecraft. Propellantless propulsion of the spacecraft may thus be achieved. Moreover, due to the symmetric nature of the movement of the two tracks 120A, 120B, masses 140A, 140B, etc., there is always a force component on the track 120B that cancels any force component on the track 120A orthogonal to the 270° direction. Thus, there are never any combined force components orthogonal to the propulsion direction, which might otherwise complicate or otherwise adversely affect the movement of the impulse momentum propulsion apparatus 100. That is, a net reaction force acting on the counterbalance track 120B over a full rotation of the counterbalance track 120B includes a non-zero propulsive force component in the propulsion direction that is additive with the propulsive force component produced by the net reaction force acting on the primary track 120A, and the net reaction force acting on the counterbalance track 120B further includes an orthogonal component orthogonal to the propulsion direction that cancels an orthogonal component, orthogonal to the propulsion direction, of the net reaction force acting on the primary track 120A.

In the example shown in FIGS. 3A-3I, the movement of the primary mass 140A from the proximal end of the primary track 120A to the distal end of the primary track 120A due to centrifugal force is controlled to occur over the course of a half rotation of the primary track 120A. This can be achieved in various ways. For example, the rotational actuator 150A, powered by the power source 110, may control the speed of the rotation of the primary track 120A such that movement of the primary mass 140A from the proximal end of the primary track 120A to the distal end of the primary track 120A due to centrifugal force occurs over the course of a half rotation of the primary track. Practically, the linear position sensor 170A may be arranged to detect a linear position of the primary mass 140A relative to the primary track 120A and the rotational actuator 150A may control the speed of the rotation of the primary track 120A based on an output of the linear position sensor 170A.

Mechanisms other than rotational speed, such as friction between the mass 140A and the primary track 120A, may be used as well in controlling the movement from proximal end to distal end to occur over a half rotation. For example, friction may be selected (by appropriate selection of materials) in order to achieve a slow enough linear movement from proximal end to distal end relative to a desired rotational speed. If, as described above, the primary track 120A includes a chamber 126A filled with a viscous fluid 128A that the primary mass 140A traverses as it moves along the primary track 120A, the movement of the primary mass 140A from the proximal end of the primary track 120A to the distal end of the primary track 120A due to centrifugal force may be slowed by the viscous fluid 128A. Similarly, if the primary track 120A includes a control solenoid (e.g. the control solenoid of the primary linear actuator 124A) that the primary mass 140A moves through as it moves along the primary track 120A, the movement of the primary mass 140A from the proximal end of the primary track to the distal end of the primary track 120A due to centrifugal force may be slowed by a magnetic force caused by application of an electric current to the control solenoid. Generally speaking, the primary linear actuator 124A, whether operating using a control solenoid, linear motor, piston, pulley, etc., may be used to slow the primary mass 140A. That is, the movement of the primary mass from the proximal end of the primary track 120A to the distal end of the primary track 120A due to centrifugal force may be slowed by a counter movement of the primary mass 140A by the primary linear actuator 124A.

Furthermore, in the example shown in FIGS. 3A-3I, the primary linear actuator 124A moves the primary mass 140A from the distal end of the primary track 120A to the proximal end of the primary track over the course of a half rotation of the primary track 120A. Generally, this can be achieved in the same ways that the movement of the primary mass 140A from the proximal end to the distal end can be controlled as described above. As another example, as the primary linear actuator 124A actively moves the mass 140A from the distal end to the proximal end of the primary track 120A, the primary linear actuator 124A may move the primary mass 140A based on an output of the rotational position sensor 160A.

The above mechanisms for controlling the movement of the primary mass 140A from one to the other end of the primary track 120A over the course of a half rotation of the primary track 120A apply equally for controlling the movement of the counterbalance mass 140A from one to the other end of the counterbalance track 120B over the course of a half rotation of the counterbalance track 120B. Namely, the various components of the impulse momentum propulsion apparatus 100 associated with the counterbalance disc 135B may be used in place of those associated with the primary disc 135A.

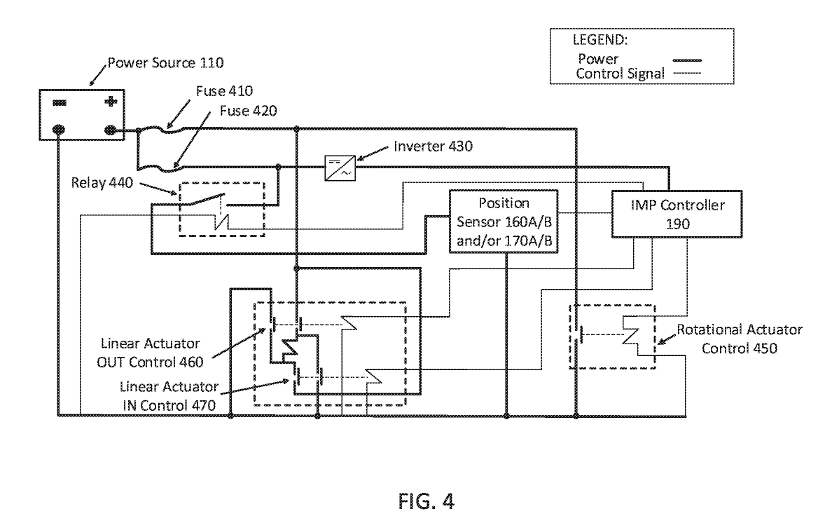

FIG. 4 illustrates an example control diagram of the impulse momentum propulsion apparatus 100. As shown in FIG. 4, the power source 110 may provide electrical power to various components of the impulse momentum propulsion apparatus 100 including the IMP controller 190 (via a power inverter 430), rotational and linear position sensors 160A, 160B, 170A, 170B (via a relay 440), and control circuits for rotational and linear actuators 150A, 150B, 124A, 124B. One or more fuses 410, 420 may be provided to protect the circuitry. Upon receipt of a pre-programmed control signal from the IMP controller 190, the relay 440 may close to provide power to one or more of the rotational and linear positions sensors 160A, 160B, 170A, 170B, which may then provide sensor signals to the IMP controller 190. For example, the primary linear position sensor 170A may provide a signal to the IMP controller 190 indicating a sensed linear position of the mass 140A relative to the primary track 120A. Based on one or more such sensor signals, the IMP controller 190 may send control signals to one of more of the control circuits for rotational and linear actuators 150A, 150B, 124A, 124B. For example, the IMP controller 190 may send a control signal to a rotational actuator control 450 that energizes one or more portions of electromagnetic guide coils by which the rotational actuator 150A or 150B rotates its respective track 120A or 120B. As another example, the IMP controller 190 may send a control signal to a linear actuator OUT control 460 or a linear actuator IN control 470 that respectively move a mass 140A or 140B outward (from a proximal end to a distal end) and inward (from a distal end to a proximal end) of its respective track 120A or 120B. Such control circuits 460, 470 may also be used to slow or oppose linear movement due to centrifugal force as described above.

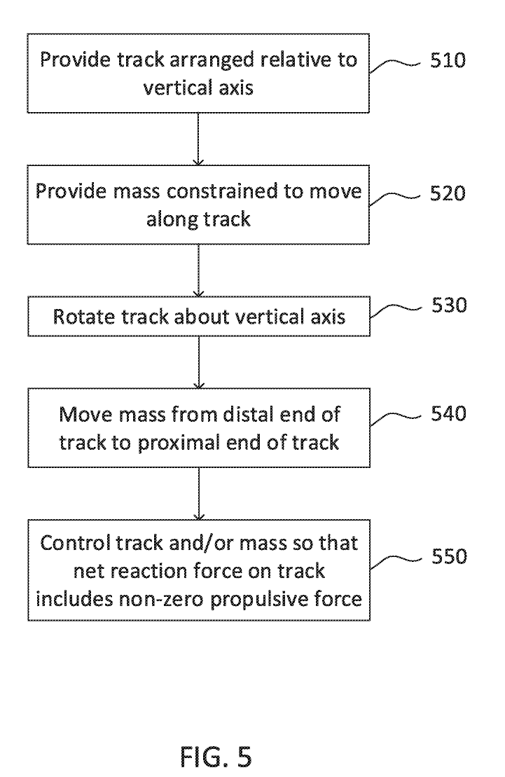

FIG. 5 illustrates an example operational flow in relation to the impulse momentum propulsion apparatus 100. As described throughout this disclosure in relation to the impulse momentum propulsion apparatus 100 shown in FIGS. 1, 2A, and 2B, a track (e.g. the primary track 120A) is provided, arranged relative to a vertical axis 130 (S510), and a mass (e.g. the primary mass 140A) is provided, constrained to move along the track (S520). For example, the track (e.g. 120A) may be arranged radially relative to the vertical axis 130 with a proximal end of the track nearest the vertical axis 130 and a distal end of the track farthest from the vertical axis 130, and the mass (e.g. 140A) may be constrained to move along the track in any of the ways described above.

With the track and mass provided, the operational flow of FIG. 5 proceeds with rotating the track about the vertical axis 130 (S530). For example, the primary rotational actuator 150A may be powered by the power source 110 and/or recycled power from the kinetic energy return 180A to rotate the primary track 120A about the vertical axis 130 as described above. As the mass moves from the proximal end of the track to the distal end of the track due to centrifugal force acting on the mass caused by the rotation of the track, the track and/or the mass is controlled such that the movement of the mass from the proximal end of the track to the distal end of the track occurs over the course of a predetermined portion of a rotation of the track, e.g. a half rotation of the track. When the mass arrives at the distal end of the track, the mass is moved from the distal end of the track back to the proximal end of the track (S540). For example, in the case of the primary track 120A, the IMP controller 190 may move the mass 140A from the distal end to the proximal end of the primary track 120A using the primary linear actuator 170A (e.g. by providing a control signal to linear actuator IN control 470) Like the movement of the mass from the proximal end to the distal end of the track, the movement of the mass from the distal end to the proximal end of the track may be controlled to occur over the course of a half rotation of the track.

The operational flow of FIG. 5 further includes controlling the track and/or mass so that a net reaction force acting on the track over a full rotation of the track includes a non-zero propulsive force component in a propulsion direction (S550). Such controlling may occur, for example, in relation to the rotation of the track in step S530 and/or the movement of the mass in step S540. For example, in the case of the primary track 120A, the IMP controller 190 may control the speed of rotation of the track via the primary rotational actuator 150A based on a sensor signal output by the primary linear position sensor 170A. Alternatively, or additionally, the speed of the linear movement of the mass 140A from the proximal end to the distal end of the primary track 120A may be controlled by a control solenoid of the primary track 120A (e.g. the control solenoid of the primary linear actuator 124A), a viscous fluid 128A, and/or other source of friction or counterforce, either passively by selection of components at the design stage or actively by the IMP controller 190 based on a sensor signal output by the primary rotational position sensor 160A. The controlling of step S550 may thus further occur in relation to the providing of the track (S510) and mass (S520) in that the materials and features may be chosen to achieve desired parameter values such as a desired friction between mass and track. The same mechanisms may be used to control movement of the mass from the distal end of the track to the proximal end of the track. For example, the IMP controller 190 may control the movement of the mass 140A from the distal end to the proximal end of the track 120A via the primary linear actuator 124A based on a sensor signal output by the primary rotational position sensor 160A.

The operational flow of FIG. 5, described above in relation to the primary track 120A, primary mass 140A, and associated components of the primary disc 135A, may be duplicated symmetrically as shown in FIGS. 3A-3I for the counterbalance track 120B, counterbalance mass 140B, and associated components of the counterbalance disc 135B. In this way, the operational flow of FIG. 5 may be used to achieve propulsion of the impulse momentum propulsion apparatus 100 in a desired propulsion direction while also avoiding combined force components orthogonal to the propulsion direction, which might otherwise complicate or otherwise adversely affect the movement of the impulse momentum propulsion apparatus 100. It should be noted that the order of the steps in FIG. 5 may be modified and various steps may be performed in parallel as can be understood from the above disclosure.

In the example described above in relation to FIGS. 3A-3I, the movements outward and inward of the masses 140A, 140B are controlled to occur over the course of respective half rotations of the tracks 120A, 120B. However, the innovations described herein are not limited to such a control scheme. By adjusting the control scheme, a variety of propulsion directions and flight paths (e.g. of a spacecraft including the impulse momentum propulsion apparatus 100) may be achievable by the principles described herein. For example, a rapid or delayed movement of the masses 140A, 140B that occurs over less or more than a full rotation of the tracks 120A, 120B may result in a change in direction of the impulse momentum apparatus 100 or hull of a spacecraft in which it is provided, after which a standard half rotation control scheme may again be followed once the new direction is established. The primary and counterbalance tracks 120A, 120B and masses 140A, 140B may even be controlled differently from each other, e.g. with the primary mass 140A moving from one to the other end of the primary track 120A over the course of a smaller or larger portion of a rotation than that by which the counterbalance mass 140B moves from one to the other end of the counterbalance track 120B. This type of control may achieve a desired curved path of the impulse momentum apparatus 100 or hull of a spacecraft in which it is provided. It is also contemplated that the primary disc 135A and counterbalance disc 135B and associated components (e.g. tracks, masses, etc.) may be in a non-parallel skewed relationship relative to the vertical axis 130, allowing for different orientations of the propulsive force. The primary disc 135A and counterbalance disc 135B and associated components may be arranged in other ways as well, including side by side in the same plane relative to the vertical axis 130, with a desired propulsive force and cancellation of orthogonal force components still being achievable by various control schemes.

In the examples described above, the linear actuators 124A, 124B may be used to accelerate the masses 140A, 140B from the distal ends to the proximal ends of the tracks 120A, 120B and further may be used to slow the masses 140A, 140B as they move from the proximal ends to the distal ends due to centrifugal force. In addition, depending on the control scheme of the apparatus 100, the linear actuators 124A, 124B may further be used to assist in the movement of the masse 140A, 140B from the proximal ends to the distal ends, e.g. to speed up rather than slow down the movement due to centrifugal force.

By using the apparatuses and methods described herein, a propellantless mechanism for propulsion may be achieved in settings where terrestrial propulsion mechanisms are impractical (e.g. in outer space). Unlike theoretical approaches to propellantless propulsion, the apparatuses and methods described herein may be readily implemented.

The above description is given by way of example, and not limitation. Given the above disclosure, one skilled in the art could devise variations that are within the scope and spirit of the innovations disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An impulse momentum propulsion apparatus comprising:
a power source;
a primary track arranged radially relative to a vertical axis with a proximal end of the primary track nearest the vertical axis and a distal end of the primary track farthest from the vertical axis, the primary track powered by the power source to rotate about the vertical axis in a first rotational direction;
a primary mass constrained to move along the primary track; and
a primary linear actuator that moves the primary mass from the distal end of the primary track to the proximal end of the primary track when the primary mass arrives at the distal end of the primary track due to centrifugal force acting on the primary mass caused by the rotation of the primary track, wherein
a net reaction force acting on the primary track over a full rotation of the primary track includes a non-zero propulsive force component in a propulsion direction.

2. The apparatus of claim 1, wherein movement of the primary mass from the proximal end of the primary track to the distal end of the primary track due to centrifugal force is controlled to occur over the course of a half rotation of the primary track.

3. The apparatus of claim 2, wherein
the primary track includes a chamber filled with a viscous fluid that the primary mass traverses as it moves along the primary track, and
the movement of the primary mass from the proximal end of the primary track to the distal end of the primary track due to centrifugal force is slowed by the viscous fluid.

4. The apparatus of claim 2, wherein
the primary track includes a control solenoid that the primary mass moves through as it moves along the primary track, and
the movement of the primary mass from the proximal end of the primary track to the distal end of the primary track due to centrifugal force is slowed by a magnetic force caused by application of an electric current to the control solenoid.

5. The apparatus of claim 4, wherein the primary linear actuator moves the primary mass by applying an electric current to the control solenoid to produce a magnetic force.

6. The apparatus of claim 2, wherein the movement of the primary mass from the proximal end of the primary track to the distal end of the primary track due to centrifugal force is slowed by a counter movement of the primary mass by the primary linear actuator.

7. The apparatus of claim 1, further comprising:
a rotational position sensor arranged to detect a rotational position of the primary track relative to the vertical axis, wherein
the primary linear actuator moves the primary mass based on an output of the rotational position sensor.

8. The apparatus of claim 1, further comprising a rotational actuator, powered by the power source, that controls a speed of the rotation of the primary track such that movement of the primary mass from the proximal end of the primary track to the distal end of the primary track due to centrifugal force occurs over the course of a half rotation of the primary track.

9. The apparatus of claim 8, further comprising:
a linear position sensor arranged to detect a linear position of the primary mass relative to the primary track, wherein
the rotational actuator controls the speed of the rotation of the primary track based on an output of the linear position sensor.

10. The apparatus of claim 1, further comprising a kinetic energy return that captures kinetic energy of the primary mass when the primary mass arrives at the distal end of the primary track due to centrifugal force acting on the primary mass caused by the rotation of the primary track.

11. The apparatus of claim 10, wherein the kinetic energy return includes a spring arranged to decelerate the primary mass when it arrives at the distal end of the primary track and accelerate the primary mass toward the proximal end of the primary track.

12. The apparatus of claim 10, wherein the primary linear actuator uses the captured kinetic energy to move the primary mass from the distal end of the primary track to the proximal end of the primary track.

13. The apparatus of claim 12, wherein the primary linear actuator is further powered by the power source.

14. The apparatus of claim 1, wherein the primary linear actuator moves the primary mass from the distal end of the primary track to the proximal end of the primary track over the course of a half rotation of the primary track.

15. The apparatus of claim 1, further comprising:
a counterbalance track arranged radially relative to the vertical axis with a proximal end of the counterbalance track nearest the vertical axis and a distal end of the counterbalance track farthest from the vertical axis, the counterbalance track powered by the power source to rotate about the vertical axis in a second rotational direction opposite the first rotational direction;
a counterbalance mass constrained to move along the counterbalance track; and
a counterbalance linear actuator that moves the counterbalance mass from the distal end of the counterbalance track to the proximal end of the counterbalance track when the counterbalance mass arrives at the distal end of the counterbalance track due to centrifugal force acting on the counterbalance mass caused by the rotation of the counterbalance track, wherein
a net reaction force acting on the counterbalance track over a full rotation of the counterbalance track includes a non-zero propulsive force component in the propulsion direction that is additive with the propulsive force component produced by the net reaction force acting on the primary track, and
the net reaction force acting on the counterbalance track further includes an orthogonal component orthogonal to the propulsion direction that cancels an orthogonal component, orthogonal to the propulsion direction, of the net reaction force acting on the primary track.

16. The apparatus of claim 15, wherein the rotation of the primary track and the rotation of the counterbalance track are in parallel planes orthogonal to the vertical axis.

17. The apparatus of claim 1, wherein the primary track is fixed to a disc that rotates about the vertical axis together with the primary track.

18. The apparatus of claim 1, wherein
the primary track includes a control solenoid that the primary mass moves through as it moves along the primary track, and
the primary linear actuator moves the primary mass by applying an electric current to the control solenoid to produce a magnetic force.

19. A spacecraft comprising:
a hull;
a power source;
a primary track arranged radially relative to a vertical axis with a proximal end of the primary track nearest the vertical axis and a distal end of the primary track farthest from the vertical axis, the primary track powered by the power source to rotate about the vertical axis in a first rotational direction relative to the hull;
a primary mass constrained to move along the primary track; and
a primary linear actuator that moves the primary mass from the distal end of the primary track to the proximal end of the primary track when the primary mass arrives at the distal end of the primary track due to centrifugal force acting on the primary mass caused by the rotation of the primary track, wherein
a net reaction force acting on the primary track over a full rotation of the primary track includes a non-zero propulsive force component in a propulsion direction of the hull.

20. A method of impulse momentum propulsion comprising:
providing a track arranged radially relative to a vertical axis with a proximal end of the track nearest the vertical axis and a distal end of the track farthest from the vertical axis;
providing a mass constrained to move along the track;
rotating the track about the vertical axis;
as the mass moves from the proximal end of the track to the distal end of the track due to centrifugal force acting on the mass caused by the rotation of the track, controlling the track and/or the mass such that the movement of the mass from the proximal end of the track to the distal end of the track occurs over the course of a predetermined portion of a rotation of the track; and
moving the mass from the distal end of the track to the proximal end of the track when the mass arrives at the distal end of the track, wherein
a net reaction force acting on the track over a full rotation of the track includes a non-zero propulsive force component in a propulsion direction.

21. The method of claim 20, wherein the predetermined portion of the rotation of the track is a half rotation of the track.
